(19) United States
(12) Patent Application Publication
(10) Pub. No.: US 2026/0047712 A1
(43) Pub. Date: Feb. 19, 2026

(54) SMART SELF SUSTAINING PARKING LOT SECURITY SURVEILLANCE DONATION AND/OR RECYCLING CENTER

(71) Applicant: Rolando Martinez, McAllen, TX (US)

(72) Inventor: Rolando Martinez, McAllen, TX (US)

(21) Appl. No.: 19/055,710

(22) Filed: Feb. 18, 2025

Related U.S. Application Data
(60) Provisional application No. 63/684,649, filed on Aug. 19, 2024.

(51) Int. Cl. A47G 29/14; G06V 20/52; G06V 20/62; G08B 13/06; G08B 13/196; H04N 7/18; H04N 23/56

(52) U.S. Cl. CPC A47G 29/141; G06V 20/52; G06V 20/625; G08B 13/06; G08B 13/19632; G08B 13/19636; H04N 7/188; H04N 23/56; A47G 2029/145

(57) ABSTRACT

A multi-functional collection box enhances the security of the surrounding environment and convenience of item collection. The box features one or more chutes for receiving various categories of items, a structural pole equipped with outward facing cameras for capturing and transmitting security footage, and flood lights for illumination. An electronic interface provides users with receipts based on the weight of their donations, measured by an internal scale within the box.

### BACKGROUND

The concept of donation and recycling boxes is well-established, with various designs implemented to facilitate the collection of items for charitable or recycling purposes. Traditional boxes typically offer a simple repository for items, but they lack features that address security concerns, provide convenience for users, and encourage responsible donation or recycling practices.

Security is a significant issue for donation boxes, as they can be targeted for theft and vandalism. Moreover, security around the donation boxes is also a significant issue, as they are often found in parking lots of businesses which may or may not be affiliated with the donation box or the organization supported by the donations. Existing solutions do not adequately deter or document such activities, as they may provide security for the contents of the box, but not the surrounding environment. Moreover, donors frequently lack the ability to obtain a receipt for their donations, which can serve as a record for personal inventory or tax deduction purposes. This lack of receipting capability reduces the incentive for individuals to donate valuable items.

### BRIEF DESCRIPTION OF THE DRAWINGS

To easily identify the discussion of any particular element or act, the most significant digit or digits in a reference number refer to the figure number in which that element is first introduced.

FIG. 1 illustrates a diagram of a collection box in accordance with one embodiment.

FIG. 2 illustrates an alternate diagram of a collection box in accordance with one embodiment.

FIG. 3 illustrates a cross-section view of a collection box in accordance with one embodiment.

FIG. 4 illustrates a flowchart 400 in accordance with one embodiment.

FIG. 5 illustrates a flowchart 500 in accordance with one embodiment.

FIG. 6 illustrates an example system diagram in accordance with one embodiment.

### DETAILED DESCRIPTION

Embodiments described herein are directed to a multi-functional collection repository that includes one or more chutes for receiving items, a structural pole equipped with security cameras, an electronic interface for issuing receipts, and an internal scale for weighing contents. According to one or more embodiments, having multiple chutes allow for the organized collection of different categories of items. The structural pole not only supports the box but also serves as a mounting point for outward facing cameras. These cameras capture security footage of the surrounding area, which can be transmitted to a remote party, enhancing the security of the box and its contents. In some embodiments, outward-facing cameras may include license plate readers or other specialized camera systems. Other optional components include one or more flood lights with optional motion sensors, and one or more solar panels which can be used to generate power stored in a power supply.

Embodiments described herein are further directed to a collection repository equipped with an electronic interface that allows users to receive a printed receipt for their donations. This interface is connected to an internal scale that weighs the contents of the box as they are deposited. The weight data is used to generate a receipt, providing donors with proof of their contribution, and potentially aiding in tax deduction processes. Other optional components include a printer for printing the receipt or other informational data, and a network interface used to transmit the donation information to a remote device. In addition, the electronic interface may be used to capture information about users of the collection repository, either through user input or other means. In some embodiments, that data may then be aggregated to provide, for example, a number of visitors, and the like.

According to one or more embodiments, the collection repository is fitted with sensors that may collect data related to movement or access of the collection repository. For example, an IMU or other motion sensor may be incorporated into the donation bin such that the IMU can track motion data for the bin. The motion data may then be compared against expected motion data to determine if unexpected motion is detected. For example, a slight jostle may be expected when a donor adds contents to the bin. However, a larger motion, such as the bin tipping over, may be considered unexpected. As another example, the collection repository may include a location sensor such as a GPS, which may be configured to track location information for the repository. Some techniques described herein are directed to comparing the detected location information for the repository to an expected location, such as a geofence. In some embodiments, if the motion or location information are unexpected, an alert may be generated and transmitted to one or more remote devices, such as an electronic device for a collection repository operator or the like.

The various components described above can be differently combined into a collection repository. Further, some components may be omitted, or others may be added. Other technical features may be readily apparent to one skilled in the art from the following figures, descriptions, and claims.

In the following description, numerous specific details are set forth to provide a thorough understanding of the various techniques. As part of this description, some of the drawings represent structures and devices in block diagram form. In this context, it should be understood that references to numbered drawing elements without associated identifiers (e.g., 100) refer to all instances of the drawing element with identifiers (e.g., 100a and 100b).

Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

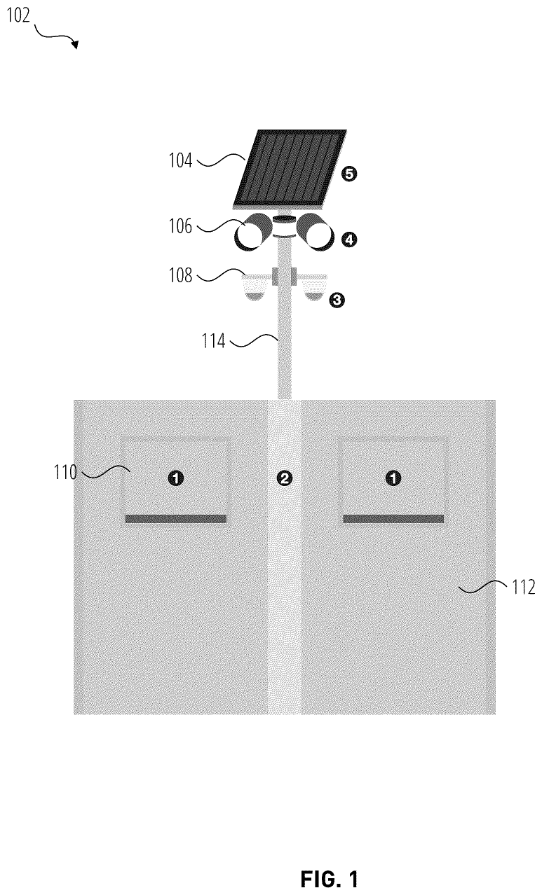

FIG. 1 illustrates a diagram of a collection repository apparatus in accordance with one embodiment. In one aspect, a collection repository 102 includes a collection box 112. The collection box 112 includes one or more chutes, such as chute 110, for receiving items. The chutes may be a same or different shape. For example, the collection box 112 may be configured to collect multiple classifications of donated or recyclable items. Each of the one or more chutes may a different geometric shape in accordance with the corresponding unique category of items. Each chute may lead to a collection volume of the box portion. For example, the collection box 112 may include multiple partitions in which the different classification of items are collected. To that end, the collection box 112 may include one or more service doors from which the collected items may be received for further processing.

According to one or more embodiments, the collection repository apparatus 102 may include a structural pole 114 extending from one or more surfaces of the collection box 112, where the structural pole 114 is configured to support accessory components of the collection repository 102, such as one or more outward-facing cameras 108 having a field of view covering a surrounding environment of the collection repository 102, and one or more storage devices (not shown) configured to store image data collected from the one or more outward facing cameras. In some embodiments, the structural pole 114 may support one or more sham outward facing cameras, such as inoperable cameras, cameras that are not operating, or other objects intended to appear to be cameras. For example, the sham outward facing cameras may include devices or components that may or may not be configured to collect image data, and may appear to be configured to collect image data. The collection repository apparatus also includes a network interface by which the image data is transmitted to a remote device associated with the surrounding environment. For example, the collection repository 102 may be situated in a parking lot of a business or organization not directly affiliated with the collection repository 102, or a service or organization for which the collected items are provided. As an example, the collection repository 102 may be associated with a non-profit organization who is the beneficiary of the items collected, but the Collection repository 102 may be placed in the parking lot of a different business or organization. Accordingly, the outward-facing cameras 108 may capture data of the environment that is of interest of the business or organization affiliated with the physical location in which the collection repository 102 is placed, and not particularly of the organization that is the beneficiary of the collected goods, or an organization providing the collection repository 102. That is, the outward-facing cameras 108 may or may not be configured to capture image data of a user placing items in the chutes 110. To that end, the captured data may be transmitted to a remote device for receipt by the business or organization affiliated with the physical environment in which the collection repository 102 is placed.

To that end, the collection repository 102 may additionally include one or more cameras configured to capture image data of a user placing items in the chute. For example, the cameras may be facing the chutes 110, and/or may include a view in front of the chute 110 from which user activity can be captured. Thus, the user-facing or chute-facing camera may differ in field of view from the outward-facing cameras 108.

The structural pole 114 may further be configured to support one or more solar panels 104. The solar panels 104 may be used to power up a power supply (not shown), which may be used to store power used to run the various electrical components of the collection repository 102. In some embodiments, solar panels may additionally, or alternatively, be attached or affixed to surfaces of the collection box 112, such as one of the sides, or a roof of the box.

The collection repository 102 may also include further includes illuminators 106 attached to the structural pole for illumination of the surrounding environment. In some embodiments, the illuminators 106 are coupled to a motion sensor, and are illuminated based on data collected by the motion sensors. For example, the illuminators 106 may be activated when motion is sensed in the surrounding environment.

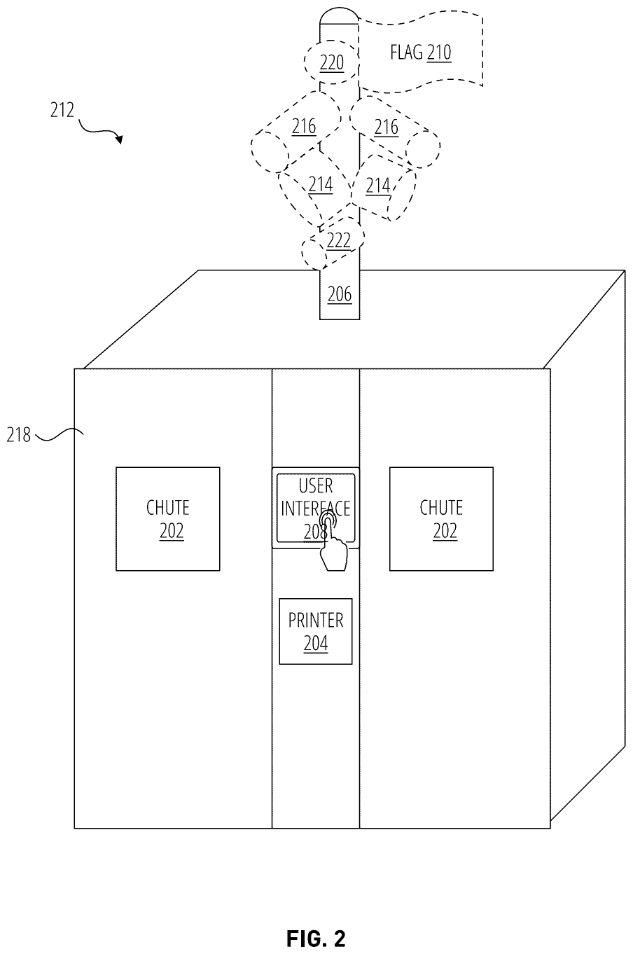

FIG. 2 illustrates an alternate diagram of a collection repository apparatus in accordance with one embodiment. In one aspect, the collection repository of FIG. 2 may be a smart repository 212, which includes a collection box 218. The collection box 218 includes one or more chutes 202 for receiving items, each chute leading to a collection volume within the collection box 218.

According to one or more embodiments, the smart repository 212 may incorporate an electronic system comprised of a computer memory on which computer readable code is stored, which is executable by a computer processor. The smart repository 212 may additionally include a user interface 208 by which a user can interact with the system in accordance with the computer readable code. For example, the user interface 208 may allow a user to provide information regarding the donated items to generate a receipt. To that end, the electronic system may additionally include a printer 204 from which the receipt can be printed.

According to one or more embodiments, when a donor approaches the smart repository 212, the user interface 208 may present a greeting. Further, the user interface may include instructional data for use of the smart repository 212, or may prompt the user to follow along a series of instructions for using the smart repository 212, which may involve the user providing user input or user feedback related to the donated items. In some embodiments, the user interface 208 may include a user input component by which a user can request assistance. For example, when selected or otherwise activated, the user input component may initiate a network connection with a remote resource. For example, the user interface 208 may initiate an automated or semi-automated chat service which, in some instances, may include an artificial intelligence-driven chatbot or other chat service. In some embodiments, the user interface 208 may transmit a signal to prompt a remote user to initiate a communication with the local user by way of the smart repository 212. For example, a chat service with a user at a remote device may be initiated, allowing the local user and remote user to communicate by way of text, audio, and/or video means. In some embodiments, the smart repository 212 may include a triggering mechanism to initiate communication service, by way of digital input component, mechanical input component such as a click-to-call button, or the like.

The user interface 208 may at least partially identify the items being placed in the chutes 202. For example, the electronic system may use image data collected from user-facing cameras or chute-facing cameras to identify items being placed in the container. For example, the electronic system may include computer readable code for object recognition, such as a trained network or other computational module configured to identify classifications of objects from image data. The user interface 208 can then present the identified classification for user approval, and/or to generate the receipt. In some embodiments, the user interface 208 may also be configured to present a user intake interface in which user data is collected. In some embodiments, the user data may be provided to a remote device associated with an organization that is the beneficiary of the collected items.

According to some embodiments, machine vision may be used to detect objects being placed into the collection box 218 in image data, for example from chute-facing cameras. In some embodiments, an artificial intelligence (AI) network may be trained under diverse scenarios. For example, images may be collected under various lighting conditions, angles, and with different types of objects routinely deposited into the repository. A model may then be trained to detect new objects captured in image data. Examples of AI networks which may be employed to recognize objects in image data include convolutional neural networks (CNNs), or the like. In some embodiments, the model may be configured to filter out false positives. For example, the model may employ a filtering technique that involves determining a confidence value for recognized objects, and identifying objects based on a threshold confidence level.

In some embodiments, the user interface 208 may additionally support network-based communication, such as VoIP, video calls, or electronic messaging. To that end, the user interface 208 may provide functionality for a user to call, message, or video chat with a service, such as a beneficiary of the provided items. Alternatively, communication connectivity can be provided by other components, such as one or more of the cameras 216.

The smart repository 212 may further includes a structural poles 206 extending from one or more surfaces of the collection box 218. The structural pole 206 may be configured to support one or more cameras 216 having one or more fields of view. For example, a first camera may be an outward-facing camera with a field of view covering a surrounding environment of the collection repository. A second camera may be configured to capture a field of view that includes a user using the smart repository 212, the opening of one or more chutes 202, or the like.

The collection smart repository 212 may also include a flag coupling member configured to support a flag 210. In addition, the smart repository 212 may include one or more illuminators 214 which can be used to light the surrounding environment and/or the smart repository 212, either continuously, on demand, or based on triggering events, such as a detected motion in the vicinity of the smart repository 212.

According to some embodiments, the smart repository 212 may additionally include an LED illuminator 220 which is configured to illuminate in accordance with a determination of how full the collection volume is. The LED illuminator 220 may be affixed to the structural pole 206, the collection box 218, or another other portion of the smart repository 212. In some embodiments, the illuminator may be powered on, or may illuminate a particular color, when the sensor data indicative of the contents of the collection box 218 is determined to satisfy a fullness threshold. For example, the detected weight from the scale may satisfy a predetermined weight limit, or a volumetric measurement may satisfy a predetermined fullness measurement. To that end, the LED illuminator 220 may be configured to indicate when the fullness threshold is satisfied for any portions of the collection box 112. As another example, an LED illuminator 220 may be provided for each portion of the collection box 112 to indicate whether an individual portion is full. The LED illuminator 220 may thus provide an indication to a passing collection vehicle that the collection box 112 is ready to be emptied. In some embodiments, the manner in which the LED is illuminated may indicate a particular fullness level. Alternatively, multiple LED illuminators 220 of different illumination types may be provided and may correspond to different fullness levels. For example, a yellow indicator at mid-level would translate to half full and a red indicator at the highest level would indicate a full receptacle that requires servicing. Additional or alternative sensors may be affixed inside the collection box 218 to determine fill level. As an example, trip sensors may be installed inside the collection box 218 which, when activated, indicate that a fullness threshold is satisfied.

According to some embodiments, the smart repository 212 may additionally include a license plate reader 222. The system may include high shutter speed cameras that can be mounted on the same structural pole as the standard security cameras or on a separate part of the box. These cameras are capable of capturing clear and legible images of license plates on vehicles traveling at higher speeds. The captured license plate data can be stored locally within the collection repository apparatus or in a secure cloud-based storage system, ensuring accessibility and security. The license plate reader 222 may continuously captures images of passing vehicle plates, or may operate during specified hours or on demand, providing flexibility in monitoring different areas. In some embodiments, the captured data is stored for a predefined retention period to comply with security and privacy regulations, and secure protocols are used to manage the data, ensuring protection from unauthorized access. In some embodiments, the license plate data may be stored in secure storage, such that authorized personnel, such as police officers, can access the stored license plate data, ensuring appropriate use.

The smart repository 212 can be integrated with other security features, such as a tamper detection system and/or GPS-based movement detection. Examples of tamper detection sensors include wireless sensors on the doors of the smart repository 212, which are configured to detect if the doors are opened outside normal business hours, or outside an expected servicing schedule. A GPS-based tracking device can be installed on the smart repository 212 detect if the box is moved beyond a predefined geofence, and the GPS unit, or other motion sensors such as an IMU, can also detect small movements, such as shaking or tipping, indicating potential tampering attempts. According to one or more embodiments, motion or location information that is unexpected may trigger an on-site alarm and cause a signal to be generated and transmitted to a monitoring service or directly to a device associated with an operator of the smart repository 212.

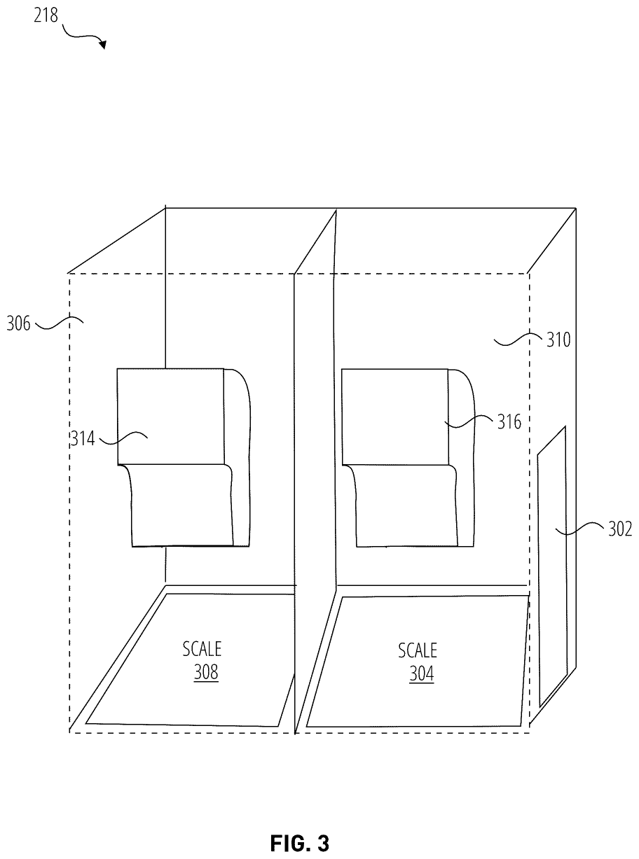

FIG. 3 illustrates a cross-section view of a collection box 218 in accordance with one embodiment. In some embodiments, the collection box 218 may include additional features to facilitate with the collection of items. For example, the collection box 218 may include multiple partitions. In the example shown, the collection box 218 includes a first collection volume 306 and a second collection volume 310. In some embodiments, each collection volume may be associated with a different classification of items. Items may be placed in the corresponding collection volume using a chute. For example, first chute 314 may be configured to accept items for first collection volume 306. Similarly, second chute 316 may be configured to accept items for second collection volume 310.

According to one or more embodiments, the first collection volume 306 comprises a scale 308 that is operatively coupled to the user interface 208. The scale 308 is configured to measure the weight of the items deposited in the first collection volume 306 and to provide weight data to the user interface 208. The weight data can be used to determine a change in weight of the contents of the first collection volume 306. The weight data can also be used to determine a fill level of the first collection volume 306. As another example, the weight from the scale can be reported to a remote device, such as a beneficiary of the provided items, such that the beneficiary organization can optimize collection schedules, determine usage, and the like.

Similarly, the second collection volume 310 comprises a scale 304 that is operatively coupled to the user interface 208. The scale 304 is configured to measure the weight of the items deposited in the second collection volume 310 and to provide weight data to the user interface 208. The weight data can be used to determine a change in weight of the contents of the second collection volume 310. The weight data can also be used to determine a fill level of the second collection volume 310.

Each collection volume may be accessed via a door, such as service door 302 that provides access to the items within the collection volume. The service door 302 can be locked or unlocked by a service personnel using a key or a code. In some embodiments, the service door 302 may be monitored by a tamper detection sensor, configured to detect when the door is open. The sensor data can be used to determine whether an unexpected access to the collection box 218 has occurred.

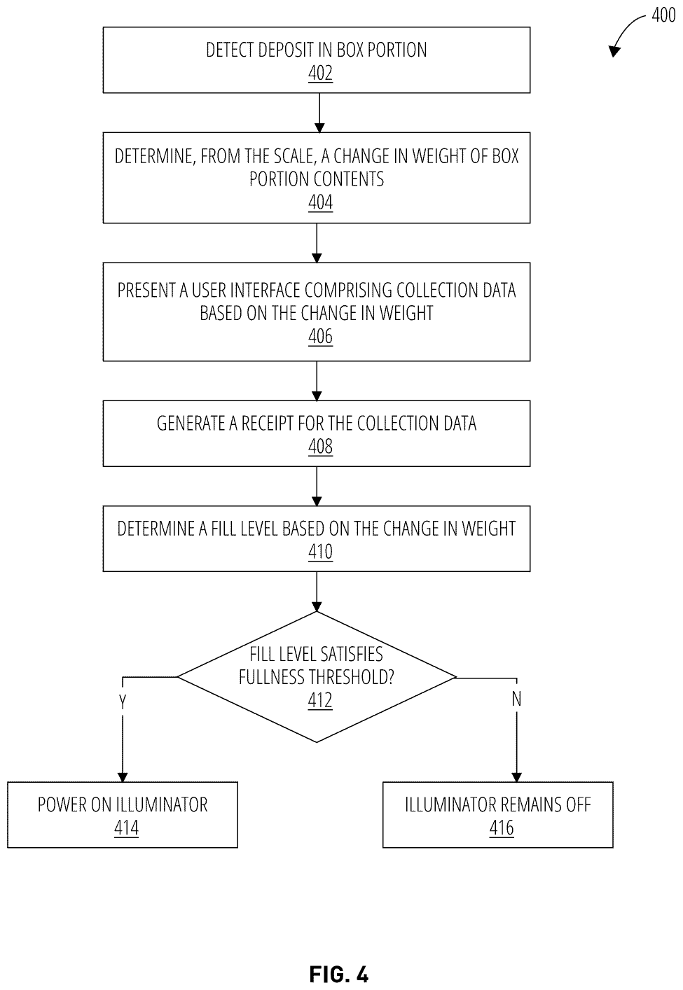

FIG. 4 illustrates an example flowchart 400 for presenting a user interface and generating a receipt based on the weight of items deposited in the collection repository apparatus. Although the example flowchart 400 depicts a particular sequence of operations, the sequence may be altered without departing from the scope of the present disclosure. For example, some of the operations depicted may be performed in parallel or in a different sequence that does not materially affect the function of the flowchart 400. In other examples, different components of an example device or system that implements the flowchart 400 may perform functions at substantially the same time or in a specific sequence.

The flowchart 400 begins at block 402, where the system detects a deposit into the collection box of a collection repository, such as first collection volume 306 or second collection volume 310. In some embodiments, the deposit may be detected based on a change in weight of box portion contents. The smart repository 212 may use various sensors, such as a motion sensor, a light sensor, or a camera, to detect the presence of a user or an item near a chute. Alternatively, the smart repository 212 may rely on the user to initiate the deposit process by pressing a button or scanning a code on the user interface 208.

The flowchart 400 proceeds to block 404, where a change in weight of the contents is determined. For example, an output from a scale in the particular potion may be tracked over time to determine a change in weight. The scale may be located in the collection volume of the box portion, and may be configured to measure the weight of the items received through the corresponding chute. The smart repository 212 may store the weight data in a memory or storage device onboard, or may transmit the weight data to a remote storage.

At block 406, the smart repository 212 may present a user interface comprising collection data based on the change in weight. The user interface may be displayed on a display device, which is comprised in or attached to the box portion. The user interface may include various information, such as the category of items deposited, the weight of items deposited, the estimated value of items deposited, the environmental impact of items deposited, or the tax deduction eligibility of items deposited. The user interface may also provide options for the user to confirm, edit, or cancel the deposit.

At block 408, the smart repository 212 generates a receipt for the collection data. The receipt may include the same or similar information as the user interface, as well as a unique identifier, a date and time stamp, a location data, or a barcode. The receipt may be generated in various formats, such as a paper receipt, an electronic receipt, or a digital receipt. In some embodiments, the user may provide user information into the user interface 208, or information about the deposited objects, for use in generating the receipt. In some embodiments, the receipt may be generated based on an estimation of the value of the contents based on weight. For example, the smart repository 212 may include computer program code for estimating a value for deposited objects based on predefined rates or rules. In some embodiments, the user information may be provided to an organization associated with the smart repository 212, for example upon user request.

The flowchart 400 proceeds to block 410, where the smart repository 212 determines a fill level based on the change in weight. The fill level may indicate the percentage of the collection volume that is occupied by the items. The smart repository 212 may calculate the fill level based on the weight data, the volume data, or the density data of the items, for example as estimated from sensors onboard the smart repository 212.

At decision block 412, the smart repository 212 determines whether the fill level satisfies a fullness threshold. The fullness threshold may be a predefined or adjustable value that indicates when the collection volume needs to be emptied or serviced, or at which point a future need to be emptied is anticipated. The fullness threshold may vary depending on the category of items, the size of the collection volume, or the frequency of collection. If the fill level satisfies the fullness threshold, the flowchart 400 proceeds to block 414, where the smart repository 212 powers on one or more illuminators. The one or more illuminators may include an LED light, a sign, or the like. The one or more illuminators may indicate to the user, the operator, or the service personnel that the collection volume is full or requires attention.

Returning to decision block 412, if a determination is made that the fill level does not satisfy the fullness threshold, the flowchart 400 concludes at block 416, where the one or more illuminators remains off. The flowchart 400 then ends. Alternatively, the flowchart 400 may loop back to block 402 to repeat the process for another deposit.

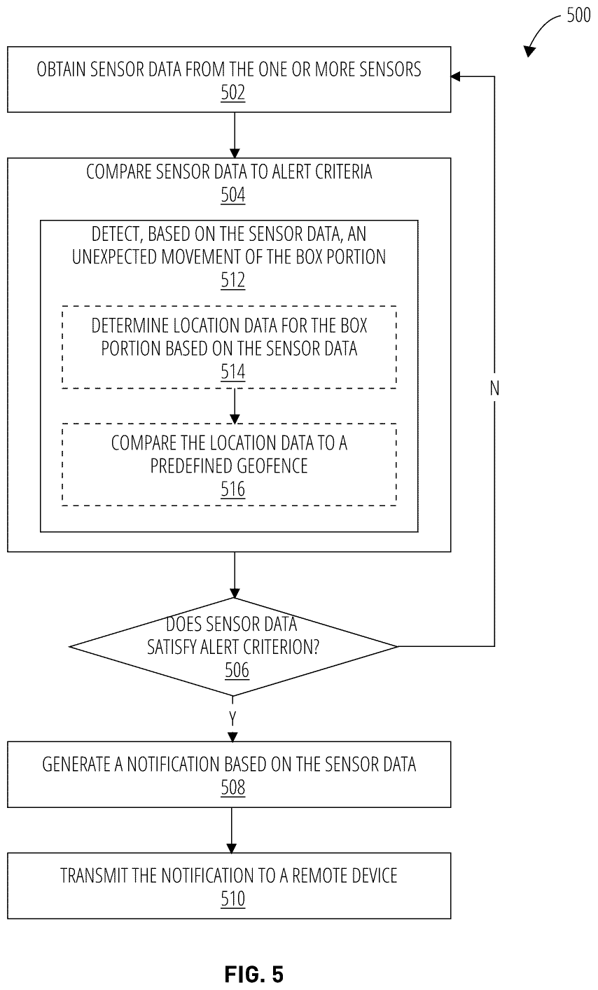

FIG. 5 depicts a flowchart 500 illustrating an exemplary method for generating and transmitting a notification based on the sensor data and the location data of the smart repository 212. Although the example flowchart 500 depicts a particular sequence of operations, the sequence may be altered without departing from the scope of the present disclosure. For example, some of the operations depicted may be performed in parallel or in a different sequence that does not materially affect the function of the flowchart 500. In other examples, different components of an example device or system that implements the flowchart 500 may perform functions at substantially the same time or in a specific sequence.

The method begins at block 502, where the smart repository 212 obtains sensor data from one or more sensors. The sensors may include various types of sensors, such as a tamper detection sensor, a license plate reader, a motion sensor, or a GPS. The sensors may be located in or on the collection box 112, the structural pole 114, or the like. The smart repository 212 may store the sensor data in a memory or storage.

At block 504, the smart repository 212 compares the sensor data to alert criteria. The alert criteria may be predefined or adjustable values or conditions that indicate an event requiring a response, a potential threat, a security breach, or the like. The alert criteria may vary depending on the type of sensors, the type of event, or the like. In some embodiments, comparing sensor data to alert criteria may include, as shown at block 512, detecting unexpected movement of the smart repository 212. The unexpected movement may include a displacement, a shaking, a tipping event, or a lifting of the box portion. The smart repository 212 may use various sensors, such as a motion sensor, a tilt sensor, or a GPS, to detect the unexpected movement.

Optionally, at block 512, the smart repository 212 determines location data for the collection box 112 based on the sensor data. The location data may include various information, such as the coordinates, the address, the distance, or the direction of the collection box 112. The smart repository 212 may use various sensors, such as a GPS, a cellular network, or a Wi-Fi network, to determine the location data. At optional block 516, the smart repository 212 compares the location data to a predefined geofence. The geofence may be a predefined virtual boundary that defines a permitted or prohibited area for the collection box 112. The geofence may be predefined or adjustable by the operator, the service personnel, or the smart repository 212. The geofence may vary depending on the location, the time, or the event.

The flowchart 500 proceeds to decision block 506, and the smart repository 212 determines whether the sensor data satisfies an alert criterion. If the sensor data does not satisfy an alert criterion, the method returns to block 502, where the smart repository 212 continues to obtain sensor data from one or more sensors.

Returning to decision block 506, if the sensor data satisfies an alert criterion, the method proceeds to block 508. At block 508, the smart repository 212 generates a notification based on the sensor data. The notification may indicate that the smart repository 212 has been moved, stolen, or vandalized, and may request assistance or intervention. The notification may include various information, such as the type of event, the type of sensor, the sensor data, the location data, or the image data. The notification may also include a request for action, a confirmation, or a cancellation. In some embodiments, generating the notification may include obtaining license plate data from a license plate reader that was captured at or near the time the alert criterion was satisfied. Other data may be included in the notification such as image or audio data captured by the smart repository 212, or the like.

The flowchart 500 concludes at block 510, where the smart repository 212 transmits the notification to a remote device. The remote device may be a device associated with an operator, service personnel, a user of the smart repository 212, or authorities such as the police, the fire department, or the like. The remote device may include various devices, such as a smartphone, a tablet, a laptop, a desktop, or a wearable device. The smart repository 212 may transmit the notification via various channels, such as a text message, an email, a phone call, an app notification, or a web notification.

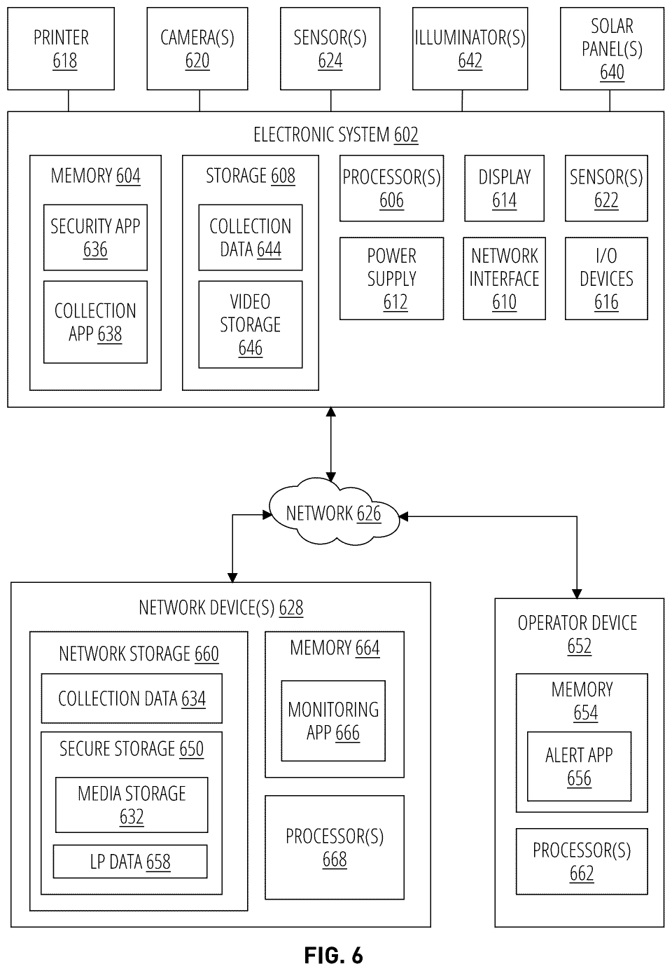

FIG. 6 illustrates an example system diagram in accordance with one embodiment. The system comprises an electronic system 602 employed as part of a smart repository 212. The electronic system 602 may include a memory 604, a processor(s) 606, and a storage 608. Memory 604 may include computer readable code executable by one or more processor(s) 606. Examples of processors include a central processing unit, processor cores, image processors, microprocessors, graphic processing units, or specialized hardware which can execute computer code or computer instructions. In addition, each of the one or more processors may include one or more processing cores. Processor(s) 606 may include one or more processors of the same or different type.

Memory 604 may each include one or more different types of memory, which may be used for performing functions in conjunction with processor(s) 606. For example, memory 604 may include cache, ROM, RAM, or any kind of transitory or non-transitory computer readable storage device capable of storing computer readable code. Examples of memory 604 include magnetic disks, optical media such as CD-ROMs and digital video disks (DVDs), or semiconductor memory devices. As used herein, non-transitory computer readable storage medium generally refers to computer accessible memory which can maintain data stored thereon for a period of time after power is removed. Examples of computer-readable storage media include solid state storage such as solid state drives, flash drives, memory cards, optical storage such as Blu-Ray or archival discs, phase-change memory (PCM) or non-volatile RAM, or other types of non-volatile memory. Memory 604 may store various programming modules and applications, such as security app 636 and collection app 638.

According to one or more embodiments, security app 636 may include computer readable code to provide security services for the surrounding physical environment. For example, security app 636 may be configured to collect image data from camera(s) 620 of the surrounding environment or the smart repository 212, and store the media items in video storage 646 of storage 608. Security app 636 may additionally or alternatively provide the camera data for storage in a network device 628, for example as media storage 632. In some embodiments, security app 636 may control illuminator(s) 642, which are configured to light the environment either on demand, based on a detected trigger, or based on instructions from the security app 636. Further, security app 636 may be configured to track sensor data to determine whether alert criteria are satisfied, and generate and transmit corresponding alerts to one or more additional devices.

Collection app 638 may be configured to facilitate usage of the smart repository 212. For example, the collection app 638 may provide a user interface through which a user can provide personal information, generate a receipt, and the like. The receipt may be printed, for example, by printer 618, which may be coupled to or incorporated in the electronic system 602. To that end, the user interface for the collection app 638 may be presented on a display 614. In some embodiments, collection app 638 can be used to determine characteristics of the items collected, for example in the form of collection data 644. Collection data 644 can be stored locally in storage 608, and/or can be provided to one or more network device(s) 628 across a network 626, such as a remote device associated with a beneficiary of the collected items. A user may interact with the collection app 638 through I/O devices 616. I/O devices 616 may include one or more keyboards, keypads, touchpads, mice, scanning devices, voice or optical recognition devices, or any other devices suitable for entering or retrieving data. Further, I/O devices 616 may include devices by which data or other output can be provided to a user, such as one or more display devices, speakers, and the like. In some embodiments, the collection app 638 can determine characteristics of the items collected based on image data captured by camera(s) 620, or otherwise detected by sensor(s) 622, and/or sensor(s) 624.

Sensor(s) 622 and/or sensor(s) 624 may include, for example, additional cameras, scales, microphones, volumetric sensors, and other components from which characteristics of the collected items can be determined. Sensor(s) 622 and/or sensor(s) 624 may further include cameras, motion sensors such as accelerometers, IMUs, gyroscopes, or the like, location sensors such as GPS or the like, and other specialized sensors, such as license plate readers and the like.

The electronic system 602 may include a power supply 612 configured to store and provide power to the various components of electronic system 602 and/or accessory components. The power supply may be charged by one or more types of power sources. According to some embodiments, power is collected from solar panel(s) 640 and stored by power supply 612 to run the various components.

The network 626 may comprise one or more wired or wireless networks, wide area networks, local area networks, short range networks, and the like. The electronic system 602 can communicate with the one or more network device(s) 628 using various communication-based technologies, such as Wi-Fi, Bluetooth, cable connections, satellite, and the like, for example using network interface 610. While shown as a single entity, network 626 may include multiple networks and devices which are not shown for clarity. For example, network 626 may include a wireless local area network accessible from an electronic system 602 via a wireless access point that is coupled, via a wired portion of the local area network to a router that is in turn coupled to the Internet. The Internet may include various sub-networks and protocols, such as the world wide web (“Web”), along with various versions of these sub-networks and protocols, such as the Web 2.0, Web 3.0, etc., and various hardware components such as servers, switches, routers, bridges, etc. that provide the services for the Internet. Users of the network device(s) 628 can interact with the electronic system 602 to access services controlled and/or provided by the electronic system 602. The electronic system 602 may use the network interface 610 to communicate with the network 626 and the network device(s) 628.

In some embodiments, operator device 652 includes one or more processor(s) 662 and one or more memory devices 654. The operator device 652 executes computer readable media including alert app 656. Alert app 656 may be configured to allow the operator device 652 to receive and respond to notifications from the electronic system 602.

The network device(s)s 628 includes network storage 660, memory 664, and one or more processor(s)s 668. The memory 664 may comprise a monitoring app 666, which may include computer readable code for accessing, viewing, and managing image data, video data, collection data, and license plate data, and the like. In some embodiments, monitoring app 666 may interface with electronic system 602 to provide parameters by which collected sensor data is to be monitored.

The network device(s) 628 may include network storage 660. Network storage 660 may include multiple types of storage, including server or data center-based storage, cloud storage, or the like. Network device(s) 628 may be configured to store collection data 634. Collection data 634 may include data related to the weight, category, and fill level of the items deposited in the collection repository apparatus, or other rules or models by which collection and management of the smart repository 212 is performed.

In some embodiments, network device(s) 628 includes secure storage 650. In some embodiments, the secure storage 650 may be a secure cloud-based storage system, with a short retention period for compliance and security. In some embodiments, secure storage 650 may be accessible via a secure protocol, which enables sharing relevant data with trusted parties, such as authorities or government agencies. Other sensitive data may be stored in secure storage 650, such as license plate data 658, or other sensitive image or audio data in media storage 632.

While the various components are presented in a particular configuration across the various systems, it should be understood that the various modules and components may be differently distributed across the network.

It should be understood that the language used in this disclosure has been principally selected for readability and instructional purposes and may not have been selected to delineate or circumscribe the disclosed subject matter. As such, the various processes may be performed by alternate components than the ones described. The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

1. A collection repository apparatus, comprising:
a box portion, comprising:
two or more chutes for receiving items, each chute leading to a collection volume of the box portion and configured to receive a unique category of items, and
a service door;
a structural pole extending from one or more surfaces of the box portion;
a chute-facing camera configured to capture image data of a user placing content in at least one of the two or more chutes in response to actuation of the at least one of the two or more chutes;
one or more outward facing cameras supported by the structural pole and having a field of view covering a surrounding environment of the collection repository apparatus;
one or more storage devices configured to store image data collected from the one or more outward facing cameras; and
a network interface by which the image data is transmitted to a remote device associated with the surrounding environment.

2. (canceled)

3. The collection repository apparatus of claim 1, wherein each of the two or more chutes have a different geometric shape in accordance with a corresponding unique category of items.

4. (canceled)

5. The collection repository apparatus of claim 1, further comprising:
a power supply,
wherein the structural pole is further configured to support one or more solar panels configured to charge the power supply.

6. The collection repository apparatus of claim 1, wherein the structural pole further comprises a flag coupling member.

7. The collection repository apparatus of claim 1, further comprising flood lights attached to the structural pole for illumination of the surrounding environment.

8. The collection repository apparatus of claim 7, wherein the flood lights are coupled to a motion sensor, and wherein the flood lights are illuminated based on data collected by the motion sensor.

9. A collection repository apparatus, comprising:
a box portion, comprising:
one or more chutes for receiving items, each chute leading to a collection volume of the box portion, wherein each collection volume comprises a scale, and
a service door;
a display;
a printer; and
a computer readable medium comprising computer readable code executable by one or more processors to:
determine, from the scale, a change in weight of box portion contents;
present a user interface comprising collection data based on the change in weight;
generate a receipt for the collection data, wherein the receipt comprises at least a unique identifier and a timestamp; and
cause the printer to print the receipt.

10. The collection repository apparatus of claim 9, further comprising:
an LED illuminator; and
computer readable code to:
determine whether a fullness threshold is satisfied based on the collection data from the scale; and
in accordance with a determination that the fullness threshold is satisfied, illuminate the LED illuminator.

11. The collection repository apparatus of claim 9, further comprising:
a structural pole extending from one or more surfaces of the box portion;
one or more outward facing cameras supported by the structural pole and having a field of view covering a surrounding environment of the collection repository apparatus.

12. The collection repository apparatus of claim 9, further comprising:
one or more storage devices configured to store the collection data and receipt records; and
a network interface by which the collection data and receipt records are transmitted to a remote device associated with an operator of the collection repository apparatus.

13. (canceled)

14. A collection repository apparatus, comprising:
a box portion, comprising:
one or more chutes for receiving items, each chute leading to a collection volume of the box portion, and
a service door;
one or more sensors comprising at least one tamper detection sensor and at least one motion sensor;
one or more processors; and
one or more computer readable media comprising computer readable code executable by the one or more processors to:
obtain sensor data from the one or more sensors,
determine that the sensor data satisfies an alert criterion, wherein the alert criterion comprises information indicative of at least one of unexpected access to the box portion, unexpected movement of the box portion, and violation of a predefined geofence, and
in response to a determination that the sensor data satisfies the alert criterion:
generate a notification based on the sensor data, and
transmit the notification to a remote device.

15. The collection repository apparatus of claim 14, further comprising:
one or more sham outward-facing cameras.

16. (canceled)

17. The collection repository apparatus of claim 14, wherein the one or more sensors comprises a license plate reader, and wherein the computer readable code to generate the notification comprises computer readable code to:
retrieve license plate data corresponding to a triggering event from which the sensor data was determined to satisfy the alert criterion; and
generate the notification based on the license plate data.

18. (canceled)

19. The collection repository apparatus of claim 14, wherein the motion sensor comprises a GPS, wherein the alert criterion comprises information indicative of violation of the predefined geofence, and wherein the computer readable code to determine that the sensor data satisfies the alert criterion, comprises computer readable code to:
determine location data for the box portion based on the sensor data, and
compare the location data to the predefined geofence.

20. The collection repository apparatus of claim 18, wherein the alert criterion comprises information indicative of unexpected movement of the box portion, and wherein the computer readable code to determine that the sensor data satisfies the alert criterion comprises computer readable code to:
detect a tipping event based on the sensor data.
